(19) United States
(12) Patent Application Publication
(10) Pub. No.: US 2010/0265329 A1
(43) Pub. Date: Oct. 21, 2010

(54) LIGHTWEIGHT PLATFORM FOR REMOTE SENSING OF POINT SOURCE MIXING AND SYSTEM FOR MIXING MODEL VALIDATION AND CALIBRATION

(76) Inventor: Robert L. Doneker, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 11/866,216

(22) Filed: Oct. 2, 2007

Related U.S. Application Data
(60) Provisional application No. 60/828,512, filed on Oct. 6, 2006.

(51) Int. Cl. H04N 7/18; H04N 5/225; G01S 19/42

(52) U.S. Cl. 348/144; 348/218.1; 342/357.25; 348/E05.024; 348/E07.085

(57) ABSTRACT

An aerial remote sensing platform remotely collects information including environmental monitoring data. The aerial remote sensing platform includes a camera, a microcontroller, and sensors. A ground base station communicates with the aerial remote sensing platform. The microcontroller monitors a pitch, a yaw, and a roll of the aerial remote sensing platform and automatically adjusts a pan and a tilt of a camera accordingly, thereby locking on a region of interest for the capture and processing of visible light and thermographic images of mixing from point source pollutant discharges. The aerial remote sensing platform auto adjustment occurs responsive to the microcontroller, which processes a variety of feedback loop information gathered by the sensors. A viewer is configured to display an analysis of the collected information including visible light and thermographic images. The analysis provided is used to validate a CORMIX simulation model for point source mixing.

### RELATED APPLICATION DATA

This application is a non-provisional application of, and claims priority to, U.S. to Provisional Patent Application Ser. No. 60/828,512, titled LIGHTWEIGHT PLATFORM FOR REMOTE SENSING OF POINT SOURCE MIXING AND SYSTEM FOR MIXING MODEL VALIDATION AND CALIBRATION, filed Oct. 6, 2006, which is hereby incorporated by reference.

### GOVERNMENT FUNDING

Some of the content herein was at least partially funded by a government contract, EP/D/06/049.

### FIELD OF THE INVENTION

This application pertains to remote sensing of point source mixing, and more particularly, to an aerial remote sensing platform for determining water temperature as a water quality parameter and indicator of pollutant transport and mixing from point source pollutant discharges.

### BACKGROUND OF THE INVENTION

Water pollution severely impacts our eco-system. Industries often discharge pollutants in their wastewater including heavy metals, oils, solids, and other toxins. Such discharges can cause death and disease to persons, animals, and plants.

Discharges can also thermally impact water quality. These thermal effects often originate from power stations or other related industries. Power stations regularly use water as a coolant, which then gets returned to the natural environment at an elevated temperature. This can distress the surrounding plants, animals, and micro organisms by decreasing the oxygen supply in the water. Fish juveniles are especially vulnerable to even small rises in temperature. A variety of aquatic life forms can be impacted including not only fish, but amphibians, copepods, and other animals and plants. Higher water temperatures can lead to increased plant growth, or algae blooms, which can in turn lead to higher metabolic rates. Increased metabolic rates can lead to food shortages and decreased biodiversity. As a result, entire food chains can be compromised or diminished.

The thermal signal resulting from a point source discharge may be used as a tracer quantity to ascertain the physical mixing and dilution of other chemical and biological discharge constituents which may be present.

Furthermore, large increases in temperature can disturb the structure of life-supporting enzymes. When enzyme activity in aquatic organisms decreases, problems such as the inability to break down lipids can lead to malnutrition. These cellular level effects can have negative impacts on mortality and reproduction rates. Thus, the problems caused by thermal pollution are severe.

During the 1970s, scientists from varying disciplines began to study in earnest the effects of thermal pollution. Early approaches employed dispersal modeling to forecast how a thermal plume (i.e., a column of one fluid moving through another) is formed from a thermal point source. A thermal point source is a single identifiable localized source of pollution, which can be approximated as a mathematical point to simplify analysis. These techniques were developed to predict the distribution of aquatic temperatures. The U.S. Environmental Protection Agency (EPA) played an early and important role in building models to predict the resulting thermal plume from a thermal point source.

Between approximately 1985 and 1995, scientists at Cornell University worked in conjunction with the EPA to develop a system named the Cornell Mixing Zone Expert System (CORMIX). CORMIX simulates mixing from point source single port, multiport diffuser, or shoreline discharges below, above, or at the water surface. The system's primary emphasis is to predict the geometry and dilution characteristics of an initial mixing zone to help facilitate compliance with water quality regulations. Used today by many commercial, government, and academic institutions, the CORMIX system continues to aid these organizations in the analysis and prediction of aqueous toxic or conventional pollutant discharges or atmospheric plumes. Mixing zones are relatively small zones, areas, or volumes, within an immediate pollutant discharge vicinity. Precautions must be taken to ensure that high initial pollutant concentrations are minimized and constrained to the mixing zones.

State and federal regulations limit mixing zone widths, cross-sectional areas, and other geometric configurations such as surface area and water depth. These and other restrictions create unique compliance challenges. In particular, the cost and complexity of measuring and validating CORMIX simulated data is high. Gathering measurement data, including temperature points, is labor intensive and traditionally conducted through sampling stations located at predetermined distances from the discharge source. Thus, building a simulation, which includes a detailed prediction of mixing zone conditions, can be accomplished using CORMIX. Other simulations can be used such as the PLUMES family of models as well as the VISJET model. But validating such simulations with empirical field observations is complex, difficult, and costly. Accordingly, a need remains for an improved system and method for collecting environmental monitoring data; in particular, a need remains for an improved system and method for monitoring thermal aqueous and atmospheric point source pollutant discharges.

### SUMMARY OF THE INVENTION

An example embodiment of the present invention may comprise a system for validating a point source mixing model, comprising two cameras fixed to a frame of an aerial platform using mounting means, the two cameras being laterally adjacent to each other and configured to jointly capture image data of substantially a same mixing zone; a microcontroller coupled to the frame of the aerial platform and coupled to the two cameras; a digital compass coupled to the microcontroller and configured to measure at least one of (a) a pitch, (b) a yaw, and (c) a roll of the aerial platform, the digital compass providing a first feedback loop to the microcontroller; a laser range finder coupled to the microcontroller and configured to determine a distance between the aerial platform and the mixing zone, the laser range finder providing a second feedback loop to the microcontroller; a first servo coupled to the microcontroller, the first servo being structured to detect a first position of the two cameras, the first servo providing a third feedback loop to the microcontroller; and a second servo coupled to the microcontroller, the second servo being structured to detect a second position of the two cameras, the second servo providing a fourth feedback loop to the microcontroller.

Another example embodiment of the present invention may be operable such that the first and second servos include first and second servo motors, respectively, the first and second servo motors being structured to automatically rotate the two cameras in at least two directions responsive to the first, second, third, and fourth feedback loops such that the at least two cameras are substantially locked to the mixing zone.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 illustrates an aerial remote sensing platform and a ground base station according to an example embodiment of the present invention.

FIG. 2 illustrates a schematic representation of the aerial remote sensing platform of FIG. 1, according to an example embodiment of the present invention.

FIG. 3 illustrates the ground base station of FIG. 1, according to an example embodiment of the present invention.

FIG. 4 illustrates a system for controlling the pan and the tilt of the cameras of FIG. 2, according to an example embodiment of the present invention.

FIG. 5 illustrates the viewer of FIG. 3, according to an example embodiment of the present invention.

FIG. 6 illustrates the viewer of FIG. 3, according to another example embodiment of the present invention.

FIG. 7 illustrates the viewer of FIG. 3, according to yet another example embodiment of the present invention.

FIG. 8 illustrates the viewer of FIG. 3, according to still another example embodiment of the present invention.

FIGS. 9 and 10 illustrate an image frame output from sensors of the present invention, including a plurality of tags, according to an example embodiment of the present invention.

FIG. 11 illustrates an image data file including the plurality of tags of FIGS. 9 and 10, according to an example embodiment of the present invention.

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

### DETAILED DESCRIPTION OF THE PREFERRED EMBODIMENT

An example embodiment of the invention includes an aerial remote sensing platform structured to collect environmental monitoring data at a field location. Specifically, the aerial remote sensing platform is structured to collect visible light and thermographic images of water flow and water temperature, to geo-reference and geo-rectify the collected data, and to display the visible light images adjacent the thermographic images using a ground base station. Water temperature may be used as a quality parameter and as an indicator of mixing from point source aqueous pollutant discharges. However, a person skilled in the art will recognize that the system described herein can also be used for monitoring thermal point source atmospheric discharges.

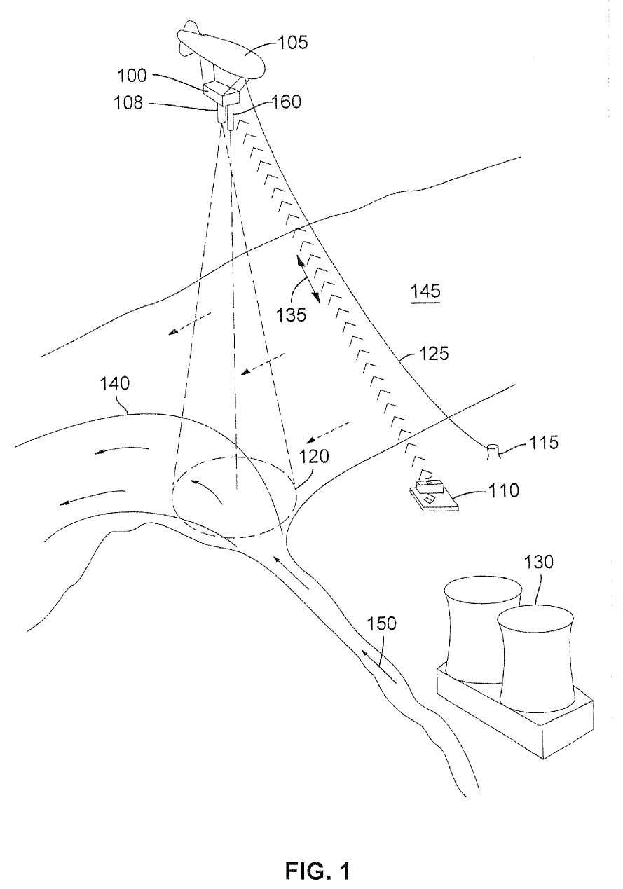

FIG. 1 illustrates an aerial remote sensing platform and a ground base station according to an example embodiment of the present invention. The aerial remote sensing platform 100 may be structured to collect information including environmental monitoring data. The ground base station 110 may control the aerial remote sensing platform 100 and may manage, parse, or display information 135 collected by the aerial remote sensing platform 100. Specifically, the aerial remote sensing platform 100 may collect and transmit the information 135 by monitoring a mixing zone 120 in an area of a pollutant discharge vicinity 140 of water 145. Dotted arrows of water 145 show a general direction of water flow. Solid arrows of a surface point source pollutant discharge 150 show a general direction of discharge flow. The discharge 150 may also be issued from a submerged or above surface diffuser pipe. The aerial remote sensing platform 100 may monitor the mixing zone 120 by using at least one camera 108. For example, the information 135 may include the environmental monitoring data collected by the aerial remote sensing platform 100, such as images captured by the at least one camera 108 and information gathered by a laser range finder 160. The information may then be transmitted to the ground base station 110 via wireless signal 135.

Similarly, the information 135 may be control information transmitted from the ground base station 110 to the aerial remote sensing platform 100. The ground base station 110 may be structured to communicate with the aerial remote sensing platform 100, to monitor a position of the aerial remote sensing platform 100, and to receive the information 135 from the aerial remote sensing platform 100. The information 135 may be transmitted wirelessly between the aerial remote sensing platform 100 and the ground base station 110. A person skilled in the art will recognize that the information 135 may also be transmitted using a conductive wire. The point source pollutant discharge 150 may originate from the power plant 130, but may also originate from other sources such as industrial plants, natural water flows, and so forth, or from submerged or above surface diffuser pipes.

In some example embodiments, the aerial lift device 105 may be a helium balloon, helicopter, glider, telescoping mast, or other type of aircraft or balloon. If a balloon is used, such as a helium balloon, a tether 125 may be coupled to the aerial lift device 105, which may be coupled to an anchor 115 to secure and to guide the aerial remote sensing platform 100. The anchor 115 may be a person or other suitable ground base anchor. If the anchor 115 is a person, the person can guide the aerial remote sensing platform 100 as by belaying the tether using carabiners. The tether 125 may be a belay rope. The position and altitidude of the aerial remote sensing platform 100 may be controlled by reeling the tether 125. Preferably, the helium balloon has a capacity of about 750 ft³ and generates about 30 lbs of net lift. However, persons having skill in the art will recognize that the capacity and the net lift can vary substantially from these values, and still provide the necessary lift and stability for the aerial remote sensing platform 100.

The aerial remote sensing platform 100, the ground base station 110, the mixing zone 120, the pollutant discharge vicinity 140, the pollutant discharge 150, and other elements of FIG. 1 are illustrative and not necessarily drawn to scale, and may be located at substantially different locations with respect to each other. Furthermore, a person having skill in the art will recognize that the aerial remote sensing platform 100 and the ground base station 110 may be used to monitor aquatic flows and mixing from point source pollutant discharges in streams, rivers, lakes, reservoirs, estuary or coastal waters, as well as thermal point source atmospheric discharges.

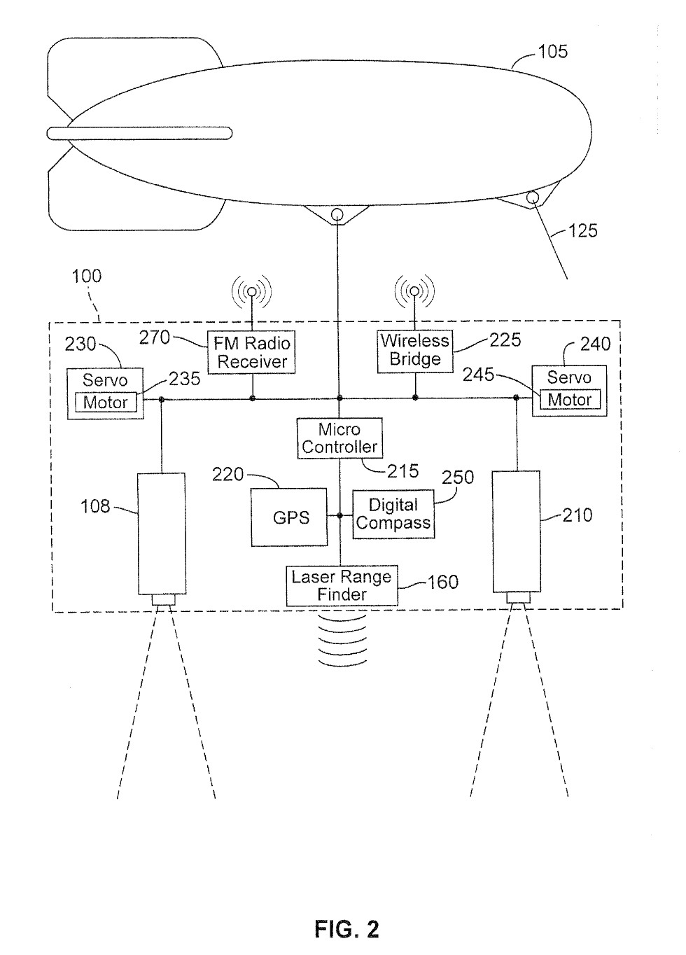

FIG. 2 illustrates a schematic representation of the aerial remote sensing platform of FIG. 1, according to an example embodiment of the present invention. In one example embodiment, the aerial remote sensing platform 100 may include a camera 108, a camera 210, a microcontroller 215, and a global positioning system (GPS) 220. The ground base station 110 may be structured to communicate with the microcontroller 215 of the aerial remote sensing platform 100 and to monitor a position of the camera 108 and the camera 210. A remote wireless bridge 225 may be coupled to the camera 108, the camera 210, and the microcontroller 215. The remote wireless bridge 225 may be structured to wirelessly transmit the information 135 (of FIG. 1) to the ground base station 110 and to wirelessly receive the information 135 (of FIG. 1) from the ground base station 110.

In another example embodiment, the aerial remote sensing platform 100 may include at least two servos 230 and 240 structured to apply a pan and a tilt to each of the cameras 108 and 210 using associated servo motors 235 and 245, respectively. The servo motors 235 and 245 may provide a feedback loop to the microcontroller. The aerial remote sensing platform 100 may include a camera position sensor, e.g., digital compass 250, which may operate in association with the servo motors 235 and 245 to provide another feedback loop to the microcontroller 215. The digital compass 250 may be particularly helpful to process and interpret images captured by cameras 108 and 210 at oblique angles. Furthermore, the digital compass 250 may provide data to the microcontroller 215 to stabilize the cameras 108 and 210 using the servo motors 234 and 245. In some embodiments, the digital compass 250 may be structured to measure a pitch, a yaw, a heading, and a roll of the aerial remote sensing platform 100, which may then be provided to the microcontroller 215 or the ground base station 110.

In some embodiments, the aerial remote sensing platform 100 may include the laser range finder 160 structured to determine a distance between the aerial remote sensing platform 100 and substantially a ground level, which provides yet another feedback loop to the microcontroller 215. The laser range finder 160 provides highly accurate distance measurements, which allows the person or equipment controlling the position of the aerial remote sensing platform 100 to keep the platform in a substantially stable position over the mixing zone 120.

The microcontroller 215 may be structured to minimize effects of movements or sway of the aerial remote sensing platform 100 by processing the feedback loops, and adjusting the pan and the tilt of the cameras accordingly. For example, a region of interest (e.g., the mixing zone 120 of FIG. 1) can be designated using at least one of the cameras and the ground base station 110 (of FIG. 1). The region of interest may be manually designated by adjusting the pan and the tilt of the cameras responsive to a manual control of at least one instrument of the ground base station 110 (of FIG. 1). Once the region of interest is designated, the microcontroller 215 may automatically adjust the pan and the tilt of the cameras using servo motors 235 and 245 responsive to the feedback loops, such as the pitch, yaw, heading, and roll measured by the digital compass 250. As such, the aerial remote sensing platform 100 may substantially lock on the region of interest during the capturing of images by the cameras 108 and 210. This enhances the accuracy and quality of the images.

Still referring to FIG. 2, the camera 108 may be a visible light camera and the camera 210 may be an infrared camera. The visible light camera 108 may be structured to capture and transmit visible light images of the region of interest (e.g., the mixing zone 120 of FIG. 1) to the ground base station 110 (of FIG. 1). The visible light camera 108 may preferably be a 3-megapixel video camera or a still shot camera. Persons with skill in the art will recognize that cameras with higher or lower resolution may be used. The visible light camera 108 may be powered by a 12V Sealed Lead Acid (SLA) battery. The infrared camera 210 may be structured to capture and transmit thermographic images of substantially the same region of interest to the ground base station 110 (of FIG. 1). The infrared camera 210 may include a Focal Plane Array (FPA), un-cooled microbolometer detector, with a 160×120 pixel array, and may be structured to collect absolute temperature data.

In some embodiments, the aerial remote sensing platform 100 may include an FM radio receiver 270 structured to receive commands from the ground base station 100 as a means of providing redundant (i.e., backup) control. The FM radio receiver 270 may receive commands to adjust the pan and the tilt of the cameras 108 and 210, among other operations. In some embodiments, the aerial remote sensing platform 100 may include the GPS 220, which may be coupled to the microcontroller 215, the GPS 220 being structured to generate a latitude measurement and a longitude measurement of the aerial remote sensing platform. The latitude and longitude measurements may then be transmitted to the ground base station 110 (of FIG. 1).

The remote wireless bridge 225, the microcontroller 215, the cameras 108 and 210, the digital compass 250, the laser range finder 160, the GPS 220, and the ground base station 110 may be internet protocol (IP) addressable and may share a same subnet. Therefore, the ground base station 110 may be configured to communicate with each of the remote aerial wireless bridge 225, the microcontroller 215, the cameras 108 and 210, the digital compass 250, the laser range finder 160, and the GPS 220. The communication may include the 802.11g protocol, which is prevalent and easy to use. However, a person skilled in the art will recognize that other protocols may be used. The cameras 108 and 210 and the microcontroller 215 may be coupled to the remote wireless bridge 225 using standard Ethernet cables. The digital compass 250, the laser range finder 160, the servos 230 and 240, and the GPS 220 may be coupled to the microcontroller using serial connections. Persons skilled in the art will recognize that other types of connections may be used.

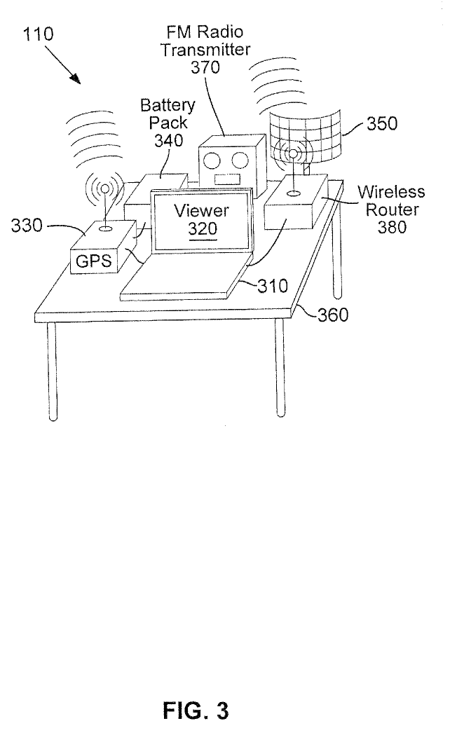

FIG. 3 illustrates the ground base station of FIG. 1, according to an example embodiment of the present invention. The ground base station 110 may include a portable computer 310 including a viewer 320 configured to analyze a plurality of frame pairs (not shown), each frame pair comprising a visible light image (not shown) and a thermographic image (not shown). In one example embodiment, the ground base station 110 may include a base wireless router 380 coupled to the portable computer 310, the base wireless router 380 structured to exchange at least one wireless signal with the remote aerial wireless bridge 225 (of FIG. 2). The wireless signals may include the information 135 (of FIG. 1) collected by the aerial remote sensing platform 100 (of FIG. 1) and the information 135 (of FIG. 1) transmitted from the ground base station 110 to the remote aerial wireless bridge 225 (of FIG. 2).

In another example embodiment, the ground base station 110 may include a GPS 330 coupled to the portable computer 310 or the aerial remote sensing platform 100. The GPS 330 may be structured to generate a latitude measurement and a longitude measurement of the ground base station 110, and to transmit the latitude measurement and the longitude measurement to the portable computer 310. In one example embodiment, it may be advantageous to use the GPS 330 rather than GPS 220 (of FIG. 2) because GPS 330 is located on the ground and can be comprised of a more expensive and accurate—but heavier—model. In another example embodiment, it may be advantageous to use the GPS 220 (of FIG. 2) because even though it may be a lighter model for easy coupling to the aerial remote sensing platform 100 (of FIG. 1), nonetheless the GPS 220 (of FIG. 2) can provide accurate measurements of the location of the aerial platform 100 (of FIG. 1). In yet another example embodiment, both the GPS 330 and the GPS 220 are used in conjunction or separately to geo-reference or geo-rectify image data.

In some example embodiments, the ground base station 110 may include a battery pack 340 structured to provide power to the base wireless router 380. However, a person with skill in the art will recognize that the battery pack 340 may also be used to power other devices in the vicinity of the ground base station 110. The battery pack 340 may include two 6V SLA batteries connected in parallel. Backup battery packs may be used to extend deployment time.

The ground base station 110 may also include a square grid parabolic antenna 350 structured to strengthen and provide directional guidance to the wireless signals. The square grid parabolic antenna 350 may provide about 24 dBi of gain. Transmitting power is the actual amount of power, in watts, of radio frequency energy that a transmitter produces at its output. If the transmitting power is too low, the signal is not strong enough for the receiver to establish a connection. Particularly in a field-deployment mode, it is possible to experience substantial signal loss, leading to data transmission and communications failures. This may be overcome by coupling the square grid parabolic antenna 350 to the base wireless router 380 to boost the signal of the base wireless router 380, and to give strength to reach over the local topography.

The table 360 may be used to provide a surface for the components of the ground base station 110. However, persons skilled in the art will recognize that any surface sufficiently effective to arrange the various components of the ground base station 110 can be used. In one example embodiment, the ground base station 110 may include an FM radio transmitter 370 structured to send commands to the FM radio receiver 270 (of FIG. 2) of the aerial remote sensing platform 100 (of FIG. 1). This may provide a manual override to adjust the pan and the tilt of the cameras 108 and 210 (of FIG. 2).

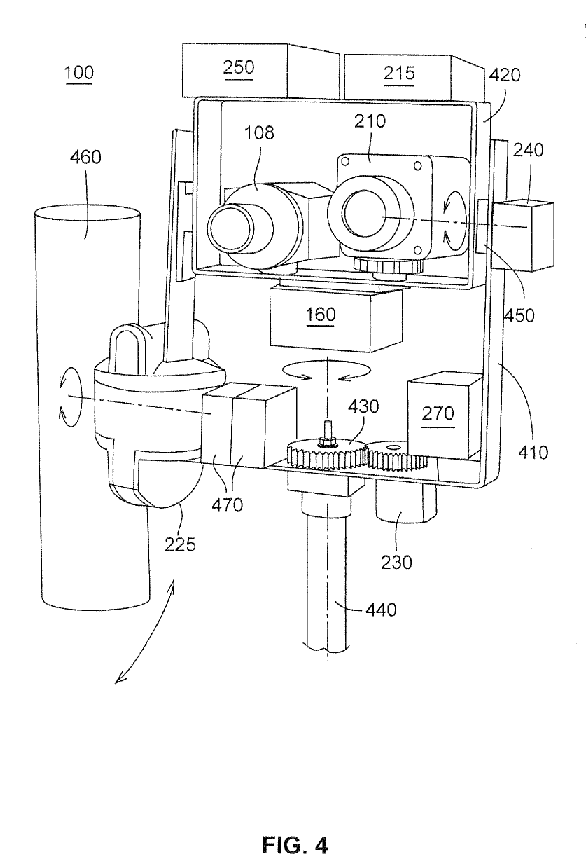

FIG. 4 illustrates a system for controlling the pan and the tilt of the cameras of FIG. 2, according to an example embodiment of the present invention. In one example embodiment, the cameras 108 and 210 of the aerial remote sensing platform 100 may be mounted on an inner frame 420. The inner frame 420 may be coupled to an outer frame 410. The inner and outer frames 420 and 410 are preferably comprised of high strength aluminum, but can also be comprised of other high strength or light weight materials. The inner and outer frames 420 and 410, respectively, are preferably “U” frames or square frames, which together are configured to tilt in one direction and pan in a different direction. The outer frame 410 may have the servo 230 mounted thereon, and coupled to a gear assembly 430. The gear assembly 430 may be comprised of one or more gears. The gear assembly 430 and the frame 410 may be coupled to mount 440, which may be attached to the aerial lift device 105 (of FIG. 1). The servo 230 may be controlled by the microcontroller 215 (of FIG. 2) or the ground base station 110 (of FIG. 1) to rotate the cameras 108 and 210 in a first direction.

The servo 240 may be mounted on either the inner frame 420 or the outer frame 410, and coupled to a gear assembly 450. The gear assembly 450 may be comprised of one or more gears. The servo 240 may be controlled by the microcontroller 215 (of FIG. 2) or the ground base station 110 (of FIG. 1) to rotate the cameras 108 and 210 in a second direction different than the first direction. A person with skill in the art will recognize the gear assemblies 430 and 450 may be positioned differently or may be comprised of varying sizes and shapes of gears.

In some example embodiments, the aerial remote sensing platform 100 may include a cantenna 460 to provide gain and directionality to the remote wireless bridge 225. This ensures good wireless connectivity even in field deployment scales and over large vertical distances. The cantenna 460 may be rotated to achieve optimum wireless connectivity. In other example embodiments, the aerial remote sensing platform 100 may include batteries 470, FM radio receiver 270, digital compass 250, microcontroller 215, or laser range finder 160.

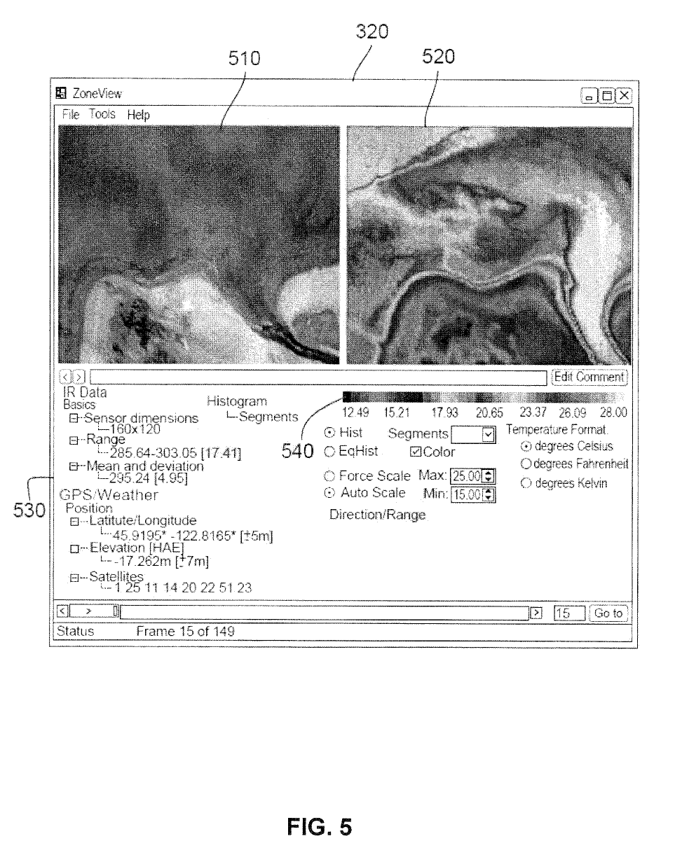

FIG. 5 illustrates the viewer of FIG. 3, according to an example embodiment of the present invention. The viewer 320 was designed and named ZoneView™ by the applicant. It may be configured to analyze a plurality of frame pairs (e.g., 510 and 520). The image 510 may be a visible light image of the mixing zone 120 (of FIG. 1) and the image 520 may be a thermographic image of substantially the same mixing zone 120 (of FIG. 1), which may be displayed with a temperature color scale 540. In some example embodiments, the viewer 320 may be configured to geo-rectify or geo-reference the visible light image 510 and the thermographic image 520 responsive to the latitude measurement and the longitude measurement of the UPS 330 (of FIG. 3) or the GPS 220 (of FIG. 2). In some example embodiments, the viewer 320 may be configured to display an analysis 530 of the information 135 (of FIG. 1) received from the aerial remote sensing platform 100 (of FIG. 1) including each of the plurality of frame pairs (e.g., 510 and 520). The visible light image 510 may be displayed substantially adjacent to the thermographic image 520. The analysis 530 may be used to validate a CORMIX simulation model or other mixing zone model for point source mixing such as a PLUMES simulation model or a VISJET simulation model. The validation of the CORMIX simulation may be accomplished by manually reviewing the analysis 530 or by linking the analysis 530 automatically to parameterize the simulation model.

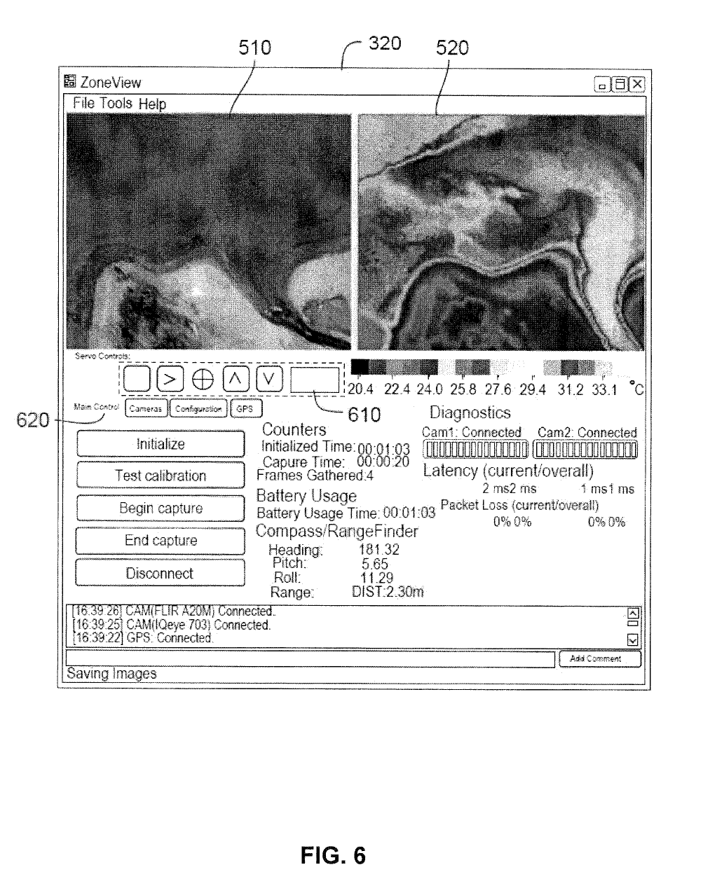

FIG. 6 illustrates the viewer of FIG. 3, according to another example embodiment of the present invention. The viewer 320 may include servo controls 610 which may be structured to control the pan and the tilt of the cameras. The viewer 320 may also include a main control 620, which provides a plurality of selectable functions including: initialize, test calibration, begin capture, end capture, and disconnect. The main control 620 may also provide status information including: initialized time, capture time, frames gathered, battery usage time. Compass information including pitch, yaw, heading, and roll (provided by digital compass 250 of FIG. 2) and range information (provided by laser range finder 160 of FIG. 1) may also be displayed. Diagnostics information such as connectivity status, latency, and packet loss may also be included in the main control 620.

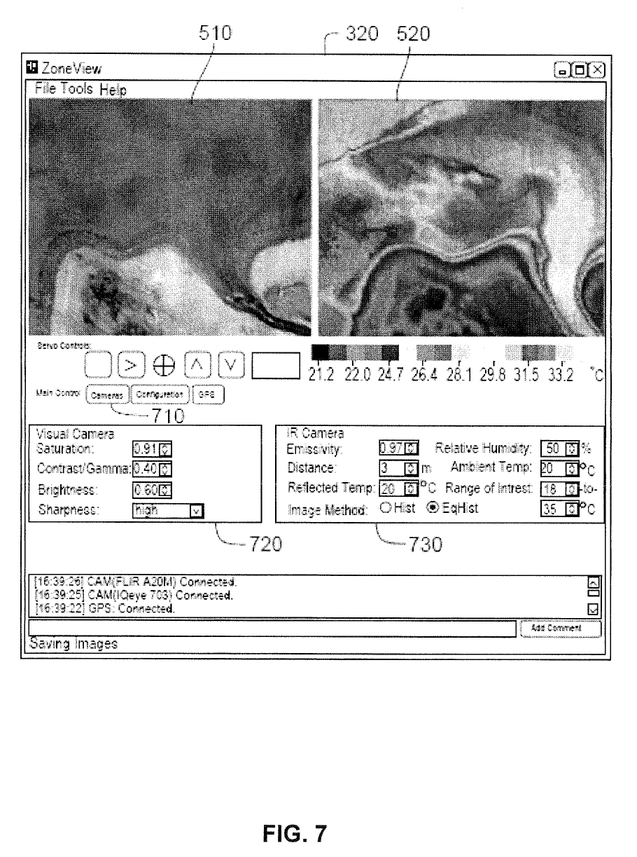

FIG. 7 illustrates the viewer of FIG. 3, according to yet another example embodiment of the present invention. The viewer 320 may include a camera control 710 structured to control the visible light camera 108 (of FIG. 1) and the infrared camera 210 (of FIG. 2). The visible light camera control 720 may include an ability to adjust a sharpness setting, a brightness setting, a gamma setting, and a saturation setting. The infrared camera control 730 may include an ability to adjust at least one temperature setting, a distance setting, a humidity setting, and an emissivity setting.

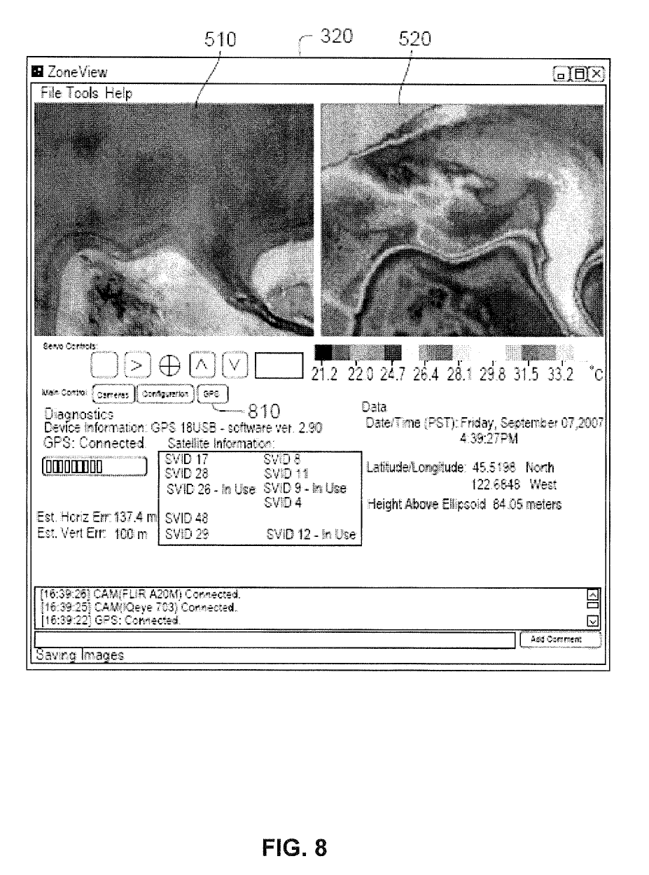

FIG. 8 illustrates the viewer of FIG. 3, according to still another example embodiment of the present invention. The viewer 320 may include a GPS control 810 structured to display information concerning the GPS 330 (of FIG. 3) or GPS 220 (of FIG. 2). The GPS control 810 may display diagnostics information, device information such as model and software version, connectivity status, and other information such as date, time, latitude, longitude, and height. This information may be used to aid in geo-rectifying and geo-referencing frame pair 510 and 520.

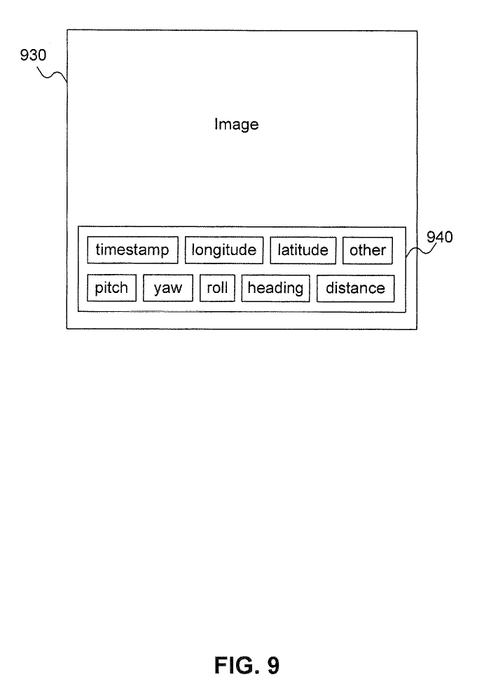

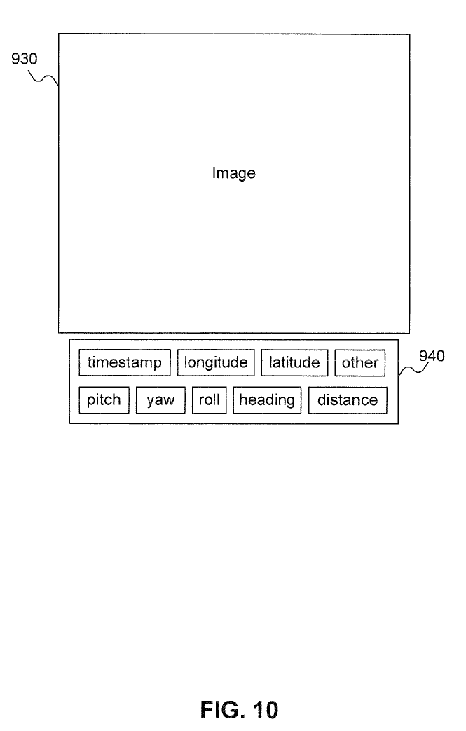

FIGS. 9 and 10 illustrate an image, according to an example embodiment of the present invention. In some example embodiments, the image 930 may be a visible light image or an infrared image. At least one of the viewer 320 (of FIG. 3), the visible light camera 108 (of FIG. 1), the infrared camera 210 (of FIG. 2), and the microcontroller 215 (of FIG. 2) may be configured to tag the image 930 with a plurality of tags 940 including a timestamp corresponding substantially to either (a) when the ground base station receives the images, or (b) when the cameras 108 and 210 (of FIG. 2) capture the images.

In some example embodiments, the viewer 320 (of FIG. 3) may be configured to tag the image 930 with the latitude and longitude measurements of the GPS 330 (of FIG. 3) or GPS 220 (of FIG. 2). In some example embodiments, the viewer 320 (of FIG. 3) may be configured to tag the image 930 with the pitch, the yaw, the heading, and the roll as measured by the digital compass 250 (of FIG. 2). In sonic example embodiments, the viewer 320 (of FIG. 3) may be configured to tag the image 930 with the distance between the aerial remote sensing platform 100 and substantially a ground level, as measured by the laser range finder 160 (of FIG. 1). Other information may also be included in the plurality of tags 940. The tags 940 may appear within a frame of the image 930 as shown in FIG. 9, or may appear outside of the frame of the image 930 as shown in FIG. 10. Some of the tags 940 may appear within the frame of the image 930 while other of the tags 940 appear outside of the frame of the image 930. The tags 940 may appear around the image 930 to improve an ability to geo-rectify or geo-reference the image 930.

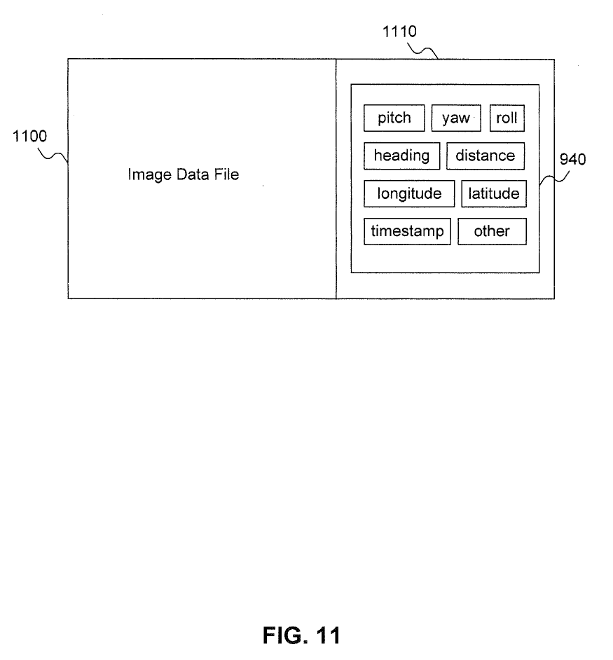

FIG. 11 illustrates an image data file including the plurality of tags of FIGS. 9 and 10, according to an example embodiment of the present invention. The image data file 1100 may include image data of the image 930 of FIGS. 9 and 10. The image data file 1100 may also include metadata 1110. The metadata 1110 may include the plurality of tags 940. The viewer 320 (of FIG. 3) may use the metadata 1110 to tag the image 930 (of FIGS. 9 and 10) with the plurality of tags 940.

The following discussion is intended to provide a brief, general description of a suitable system including at least one machine in which certain aspects of the invention can be implemented. Typically, the system may include a portable computer, which may have a system bus to which is attached processors, memory, e.g., random access memory (RAM), read-only memory (ROM), or other state preserving medium, storage devices, a video interface, and input/output interface ports. The system can be controlled, at least in part, by input from conventional input devices, such as keyboards, mice, etc., as well as by directives received from another machine, interaction with a virtual reality (VR) environment, biometric feedback, or other input signal. As used herein, the team “machine” is intended to broadly encompass a single machine, a virtual machine, or a system of communicatively coupled machines, virtual machines, or devices operating together. Exemplary machines include computing devices such as computers, workstations, servers, portable computers, handheld devices, telephones, tablets, etc., as well as transportation devices, such as private or public transportation, e.g., automobiles, trains, cabs, etc.

The machine can include embedded controllers, such as programmable or non-programmable logic devices or arrays, Application Specific Integrated Circuits, embedded computers, smart cards, and the like. The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciated that network communication can utilize various wired and/or wireless short range or long range carriers and protocols, including radio frequency (RF), satellite, microwave, Institute of Electrical and Electronics Engineers (IEEE) 545.11, 802.11g, Bluetooth, optical, infrared, cable, laser, etc.

The invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system for validating a point source mixing model, comprising:
two cameras fixed to a frame of an aerial platform using mounting means, the two cameras being laterally adjacent to each other and configured to jointly capture image data of substantially a same mixing zone;
a microcontroller coupled to the frame of the aerial platform and coupled to the two cameras;
a digital compass coupled to the microcontroller and configured to measure at least one of (a) a pitch, (b) a yaw, and (c) a roll of the aerial platform, the digital compass providing a first feedback loop to the microcontroller;
a laser range finder coupled to the microcontroller and configured to determine a distance between the aerial platform and the mixing zone, the laser range finder providing a second feedback loop to the microcontroller;
a first servo coupled to the microcontroller, the first servo being structured to detect a first position of the two cameras, the first servo providing a third feedback loop to the microcontroller; and
a second servo coupled to the microcontroller, the second servo being structured to detect a second position of the two cameras, the second servo providing a fourth feedback loop to the microcontroller,
wherein the first and second servos include first and second servo motors, respectively, the first and second servo motors being structured to automatically rotate the two cameras in at least two directions responsive to the first, second, third, and fourth feedback loops such that the at least two cameras are substantially locked to the mixing zone.

2. A system according to claim 1, further comprising a ground station structured to communicate with the aerial platform, to receive the captured image data, to display the captured image data from the two cameras side by side, and to validate the mixing model using the side by side image data.

3. A system according to claim 2, wherein the captured image data includes at least one visible light image and at least one thermographic image, wherein the ground station further comprises a viewer configured to display the visible light image substantially adjacent to the thermographic image, and wherein the viewer is configured to geo-rectify the at least one visible light image and the at least one thermographic image responsive to a global positioning system (GPS) latitude and longitude measurement of at least one of the aerial platform and the ground station.

4. A system, comprising:
an aerial remote sensing platform structured to collect first information including environmental monitoring data, the aerial remote sensing platform including at least one camera, at least one microcontroller, and at least one camera position sensor; and
a ground base station structured to communicate with the at least one microcontroller, to monitor a position of the at least one camera, and to receive the first information from the aerial remote sensing platform.

5. A system according to claim 4, wherein the aerial remote sensing platform further comprises:
a remote aerial wireless bridge coupled to the at least one camera and the at least one microcontroller, the wireless bridge structured to wirelessly transmit the first information to the ground base station, and to wirelessly receive second information from the ground base station; and
at least two servos structured to apply a pan and a tilt of the at least one camera, each of the at least two servos including at least one servo motor, the at least one servo motor providing a first feedback loop to the at least one microcontroller responsive to the camera position sensor.

6. A system according to claim 5, wherein the camera position sensor includes a digital compass structured to measure a pitch, a yaw, and a roll of the aerial remote sensing platform, the digital compass providing a second feedback loop to the at least one microcontroller, and wherein the aerial remote sensing platform further comprises:
a laser range finder structured to determine a distance between the aerial remote sensing platform and substantially a ground level, the laser range finder providing a third feedback loop to the at least one microcontroller; and
a first global positioning system (GPS) coupled to the microcontroller, the first GPS being structured to generate a latitude measurement and a longitude measurement of the aerial remote sensing platform and to transmit the latitude measurement and the longitude measurement to the ground base station.

7. A system according to claim 6, wherein the at least one camera comprises:
a visible light camera structured to capture and transmit visible light images of a region of interest of substantially the ground level to the ground base station; and
an infrared camera structured to capture and transmit thermographic images of substantially the same region of interest to the ground base station.

8. A system according to claim 7, wherein the ground base station is structured to control at least one of a sharpness setting, a brightness setting, a gamma setting, and a saturation setting of the visible light camera, and to control at least one of a temperature setting, a distance setting, a humidity setting, and an emissivity setting of the infrared camera, responsive to transmitting the second information to the remote aerial wireless bridge.

9. A system according to claim 7, wherein the microcontroller is structured to minimize effects of a movement of the aerial remote sensing platform by automatically adjusting the pan and the tilt of the at least one camera responsive to the first, second, and third feedback loops, to substantially lock on the region of interest during the capture of the visible light and the thermographic images.

10. A system according to claim 7, wherein the ground base station is structured to designate the region of interest by adjusting the pan and the tilt of the at least one camera responsive to a manual control of at least one instrument of the ground base station during the capture of the visible light and the thermographic images.

11. A system according to claim 7, wherein the aerial remote sensing platform further comprises an FM radio receiver, wherein the ground base station further comprises an FM radio transmitter, and wherein the FM radio transmitter is structured to adjust the pan and the tilt of the at least one camera responsive to a manual control of the FM radio transmitter.

12. A system according to claim 5, wherein one of the at least two servos is coupled to an inner frame and another of the at least two servos is coupled to an outer frame, the inner frame structured to control the tilt of the at least one camera responsive to the at least one servo motor, and the outer frame structured to control the pan of the at least one camera responsive to the at least one servo motor.

13. A system according to claim 7, wherein each of the remote aerial wireless bridge, the microcontroller, the visible light camera, the infrared camera, the digital compass, the laser range finder, and the ground base station are internet protocol (IP) addressable and share a same subnet, and wherein the ground base station is structured to communicate with each of the remote aerial wireless bridge, the microcontroller, the visible light camera, the infrared camera, the digital compass, and the laser range finder.

14. A system according to claim 13, wherein the ground base station further comprises:
a portable computer including a viewer configured to analyze a plurality of frame pairs, each frame pair comprising a visible light image and a thermographic image;
a base wireless router coupled to the portable computer, the base wireless router structured to exchange at least one wireless signal with the remote aerial wireless bridge, the at least one wireless signal including the first information collected by the aerial remote sensing platform and the second information transmitted from the ground base station to the remote aerial wireless bridge;
a square grid parabolic antenna structured to strengthen and provide directional guidance to the at least one wireless signal; and
a second GPS coupled to the portable computer, the second GPS being structured to generate a latitude measurement and a longitude measurement of the ground base station and to transmit the latitude measurement and the longitude measurement to the portable computer.

15. A system according to claim 14,
wherein the viewer is configured to geo-rectify and geo-reference the visible light image and the thermographic image of the plurality of frame pairs responsive to the latitude measurement and the longitude measurement measured by at least one of the first GPS and the second GPS, and
wherein the viewer is configured to tag at least one of (a) the visible light image and (b) the thermographic image with a timestamp, the timestamp corresponding substantially to a time the ground base station receives the images, and wherein the viewer is configured to tag the at least one of (a) the visible light image and (b) the thermographic image with the latitude measurement and the longitude measurement measured by at least one of the first GPS and the second GPS.

16. A system according to claim 14, wherein the viewer is configured to tag at least one of (a) the visible light image and (b) the thermographic image with the pitch, the yaw, the roll, and said distance, and wherein the viewer is configured to display an analysis of the first information, the first information including each of the plurality of frame pairs, the visible light image being displayed substantially adjacent to the thermographic image, and wherein the analysis is used to validate at least one of (a) a CORMIX simulation model for point source mixing, (b) a PLUMES model, and (c) a VISJET model.

17. A system according to claim 4, wherein the aerial remote sensing platform is coupled to an aerial lift device, the aerial remote sensing platform further comprising a first frame coupled to a second frame, the first frame having mounted thereon the at least one camera, a first servo motor coupled to at least one of the first frame and the second frame and being structured to tilt the at least one camera, the second frame being coupled to a second servo motor structured to pan the at least one camera.

18. A method for validating a point source mixing model, the method comprising:
directing two cameras at a common point;
capturing image data using the two cameras from an elevated point above the common point;
transmitting the captured image data to a ground station together with camera position data;
displaying the captured image data from the two cameras side by side; and
validating the mixing model using the side by side image data and the position data.

19. A method according to claim 18, further comprising:
maintaining an aerial platform above the common point, the aerial platform including the two cameras;
controlling an altitude of the aerial platform using a belay rope tethered to a person, the person being located substantially near the ground station; and
manually selecting a region of interest associated with the common point using at least one instrument of the ground station.

20. A method according to claim 19,
wherein capturing image data includes automatically locking the two cameras on the region of interest using a first servo to rotate the two cameras in a first direction, and using a second servo to rotate the two cameras in a second direction, the first and second camera rotations being responsive to a pitch, a yaw, and a roll of the aerial platform;
wherein displaying the captured image data further comprises tagging the image data with tags including the pitch, the yaw, the roll, and a timestamp; and
wherein the tags are used together with a longitude and a latitude measurement of at least one of the aerial platform and the ground station to geo-reference the captured image data.
